(19) United States
(12) Patent Application Publication
(10) Pub. No.: US 2005/0043966 A1
(43) Pub. Date: Feb. 24, 2005

(54) Electronic medical reference library device

(76) Inventors: Hugh F. Harnsberger, Salt Lake City, UT (US); Michael E. Hasson, Salt Lake City, UT (US); Gregory J. Phipps, Salt Lake City, UT (US)

Correspondence Address: JONES, WALDO, HOLBROOK & MCDONOUGH, PC;Attn: Brent T. Winder, Suite 1500, 170 South Main Street, Salt Lake City, UT, 84101-1644, US

(21) Appl. No.: 10/643,456

(22) Filed: Aug. 19, 2003

(51) Int. Cl. G06F 17/60

(52) U.S. Cl. 705/2; 705/3

(57) ABSTRACT

A device for storing and managing an electronic medical reference library, comprising an electronic medical reference, designated by title, displayed for electronic selection; a list of individual diagnoses, to be displayed for electronic selection after electronic selection of the electronic reference; a navigation bar, displayed after electronic selection of an individual diagnosis, having representative buttons located thereon for electronic selection; a list of key facts, related to a selected individual diagnosis, having a representative button on the navigation bar, displayed after an individual diagnosis is electronically selected or after having its representative button selected on the navigation bar; and an image, illustrating a representative view of an individually selected diagnosis, having a representative button on the navigation bar, displayed after having its representative button selected on the navigation bar.

### BACKGROUND

It is well known in many fields of knowledge or professions, such as the medical profession, to use reference books and other printed publications to assist practitioners in conducting their required duties. For example, doctors often consult medical references when diagnosing patients. These medical reference materials typically provide a variety of information, such as the names of established diagnoses, radiological images and/or medical illustrations, imaging findings, differential diagnoses, typical pathologies, common clinical issues, and a host of other helpful materials. For hundreds of years, hard bound reference books have been the dominant source of medical information. However, with the advent of electronic data storage and transfer techniques, electronic libraries are becoming widely utilized. For the purpose of illustrating the present invention, reference to the medical profession will be undertaken, but this should not be considered as limiting the scope of the invention.

### PROBLEMS RELATED WITH THE PRIOR ART

Both the conventional and modern uses of hard copy libraries and electronics databases, respectively, have inherent disadvantages for medical practitioners. Typically, hard copy reference materials are located within a central library, which is often inconvenient to visit and access at the time of a needed diagnosis. Similarly, Internet or network bound electronic databases are accessible only at designated locations, sometimes inconveniently located for physicians to access and consult.

In addition, medical reference materials, whether in hard copy or electronic form, are written in the author's prose, organized idiosyncratically with each individual author's format and wording. The constant inconsistency of format, wording, and organization greatly impedes a physician's ability to navigate texts or databases in the effort to find the relevant and appropriate information.

Medical reference materials are also inherently difficult to share. In hard copy form, physicians are forced to either copy the relevant text from a library source (often ignoring copyright laws and subjecting themselves to unnecessary illegal activity) or cut and paste relevant excerpts from electronic databases on a network or Internet website. These challenges ultimately serve as a deterrent to quickly and easily sharing valuable information between sources and/or physicians.

Finally, both hard copy and electronic information is continually lagging behind the pace of technological innovation and the accumulation of medical knowledge. Presently, there is no easy way for end users to augment third-party reference materials with updated or ground breaking information and to transmit it to members of the profession, or to simply create a fast and integrated record of personal notes, observations, or discoveries as an addition to established reference materials. Arguably, this lack of such augmented medical information could potentially create instances of medical liability for doctors that fail to maintain an active, and up to date, medical reference library.

All of the above proffered medical reference materials issues may lead one skilled in the art of medical diagnosis to conclude that the current system and method of gathering, storing, and distributing valuable medical information and knowledge is inefficient and problematic.

### SUMMARY

There is therefore provided a unique device and method for addressing, among other things, the above-identified issues. In particular, there is provided a portable medical reference library containing thousands of diagnoses on a personal digital assistant (PDA) device. There is provided a unique method and device for allowing easy access to the name of each diagnosis and relevant information regarding the diagnosis, such as: key facts, radiological images and/or medical illustrations, imaging findings, differential diagnoses, typical pathologies, typical clinical issues, and a host of other important materials. There is a unique device and method for allowing one skilled in the appropriate art to create and attach personal notes about any diagnosis provided in the library. Additionally, the present invention provides for the transfer of such personal notes, referred to as beaming information, to other enabled users in order to effectuate the sharing of information between medical colleagues.

Another unique feature of the present invention is that it provides for easy navigation between key information within each diagnosis. In addition, there is a unique feature for easily enabling unregistered users to borrow a particular book from a registered user without any cost for a short period of time, much like checking a book out from a mobile library.

An additional embodiment of the present invention is designed to encompass most any type of technology, or knowledge, to be displayed to a user over a display and navigation medium. Specifically, there is a device for an electronic medical reference library, comprising: an electronic reference title which is displayed for electronic selection, a list of individual categories of knowledge that are related to the reference title selected, a navigation bar which is displayed after electronic selection of an individual category of knowledge, a list of key facts that are related to a selected category of knowledge which are displayed after an individual category of knowledge is electronically selected or after having its representative button selected on the navigation bar, and an image which illustrates a representative view of an individually selected category of knowledge, which also has a representative button on the navigation bar, and which is displayed after having its representative button selected on the navigation bar.

Additional features and advantages of the invention will be set forth in the detailed description which follows, taken in conjunction with the accompanying drawings, which together illustrate by way of example, the features of the invention.

### BRIEF DESCRIPTION OF THE DRAWINGS

FIG. 1 shows a front panel of a typical personal digital assistant (PDA)

FIG. 2 depicts a typical application screen for a PDA.

FIG. 3 depicts an example of an Installed Titles Screen

FIG. 4 depicts an example of a Diagnosis List Screen

FIG. 5 depicts the Diagnosis List Screen of FIG. 4 shown in a scrolled position.

FIG. 6 depicts an example of a Category Pull down Menu.

FIG. 7 depicts an example of a refined Diagnosis List.

FIG. 8 depicts an example of a Key Facts Screen.

FIG. 9 depicts an example of a Picture 1 Screen.

FIG. 10 depicts an example of a Picture 1 Legend.

FIG. 11 depicts an example of a Picture 2 Screen.

FIG. 12 depicts an example of a Picture 2 Legend.

FIG. 13 depicts an example of an Imaging Findings Screen.

FIG. 14 depicts an example of a Differential Diagnosis screen.

FIG. 15 depicts an example of a Pathology screen.

FIG. 16 depicts an example of a Clinical Issues screen.

FIG. 17 depicts an example of a Selected References screen.

FIG. 18 depicts an example of a Diagnosis Options Pull Down Menu.

FIG. 19 depicts an example of a Note Screen.

FIG. 20 depicts an example of a Beam Note Option.

FIG. 21 depicts an example of an About Diagnosis window.

FIG. 22 depicts an example of a Title Information window.

FIG. 23 depicts an example of a Delete Title window.

FIG. 24 depicts an example of a Delete Title Confirmation window.

FIG. 25 depicts an example of a Title Options Pull Down Menu.

FIG. 26 depicts an example of a Title Registration Window.

FIG. 27 depicts an example of a Beam Title Confirmation window.

FIG. 28 depicts a Move Title window.

FIG. 29 depicts an About PocketRadiologist Screen.

FIG. 30 is a Navigation Map illustrating the interplay between the screens and windows depicted in FIGS. 1-29.

### DETAILED DESCRIPTION OF THE ILLUSTRATED INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

The present disclosure pertains generally to a portable medical reference library containing numerous diagnoses on a personal digital assistant (PDA) device. Although it is again noted that the device and method discussed herein are considered to have application in other fields where reference materials are consulted.

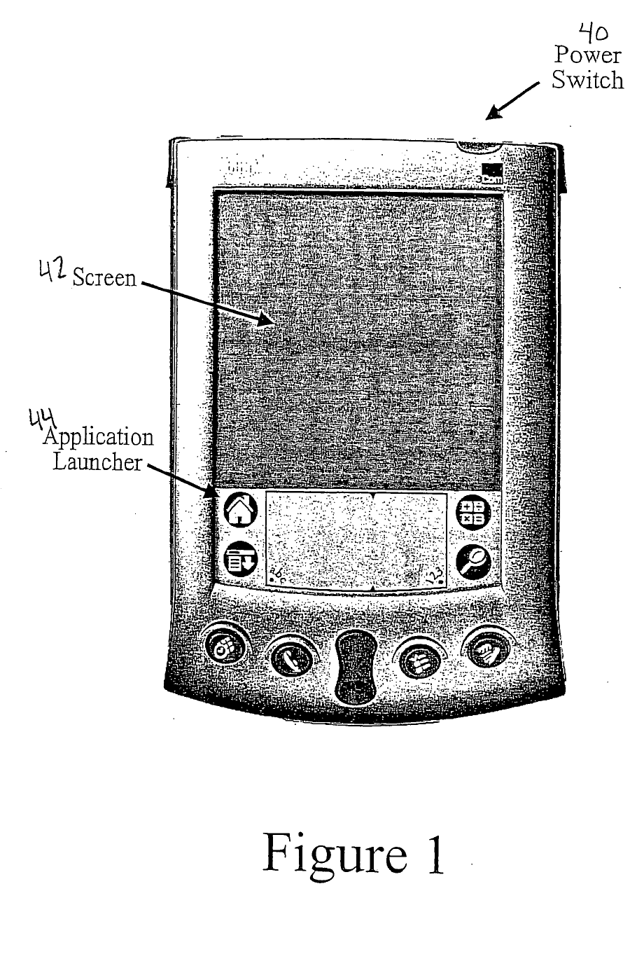

FIG. 1 depicts an example of a PDA front panel with the power off. The PDA in this depiction is modeled after the Palm™ V (available through Palm, Inc. of Milpitas, Calif.). However, it is noted that virtually any PDA could be utilized under the present invention provided it had the requisite memory and graphics capabilities.

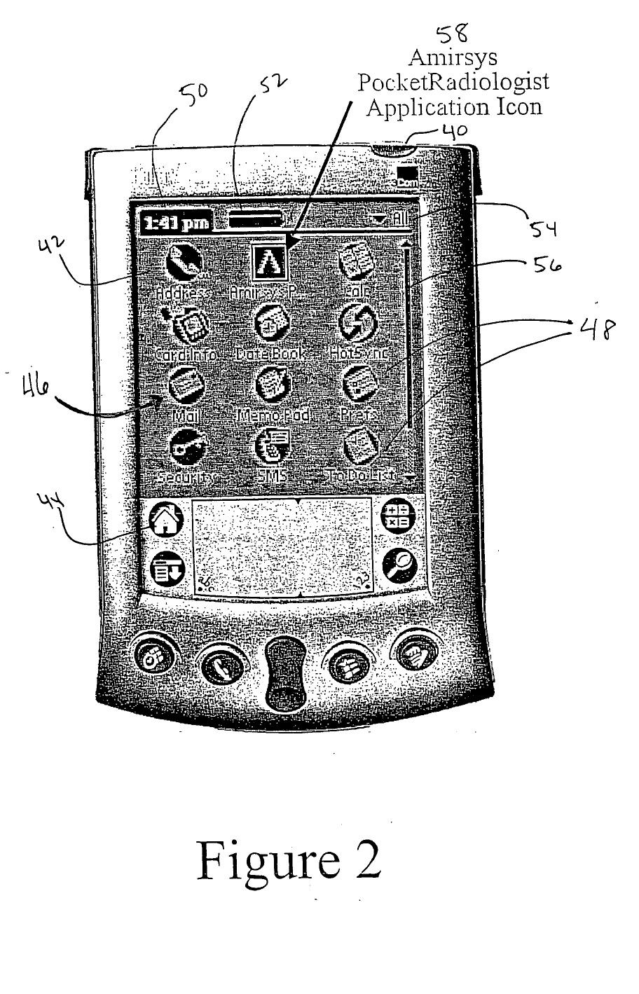

The front panel in FIG. 1 is an industry-standard interface and typically includes a power switch or button 40, a screen 42 and an application launcher 44, which is, in this example, depicted by a house-shaped icon located near the lower left of the screen. In this embodiment, a user would tap on the application launcher 44, and an applications screen 46 (FIG. 2) would then be displayed.

It is noted that different PDAs may have different mechanisms whereby applications are selected and/or opened. For example, rather than selecting and opening applications by tapping the screen, a PDA may have arrow buttons and an “Enter” button. Whatever the particular mechanism for selecting and/or opening an application, it is considered to be within the scope of the present invention.

In FIG. 2, is shown a typical applications screen 46 having general application icons 48 for various installed applications. The applications screen 46 is typically the first screen that a user sees when the PDA is turned on. This particular application screen 46 also includes a clock 50, a battery power level indicator 52, an applications category pull down menu 54, and a scroll bar 56.

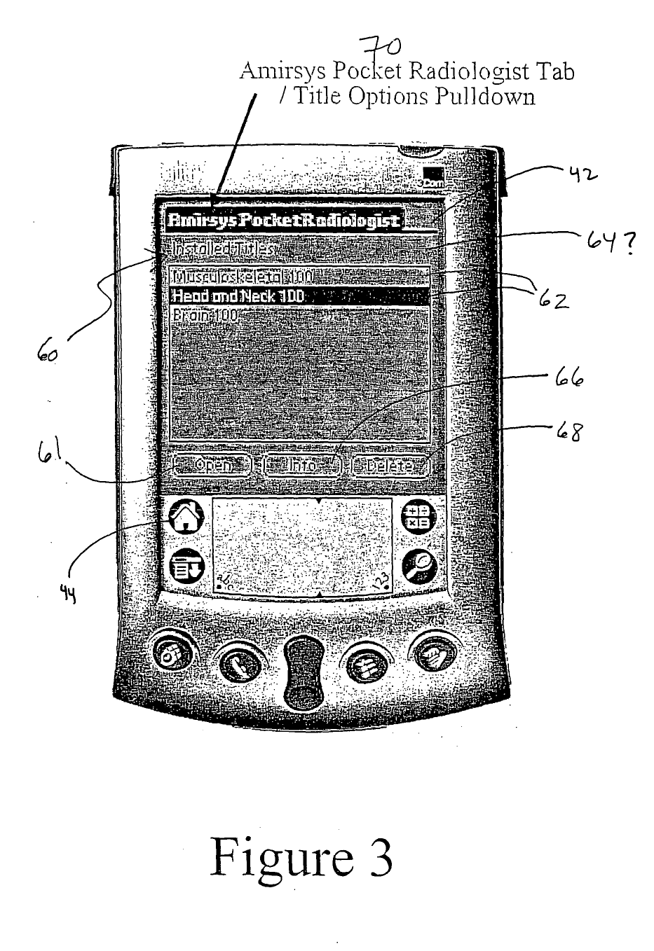

When icon 58 (which is displayed as “Amirsys PocketRadiologist” or “Amirsys P . . . ” on the applications screen 46) is tapped, the electronic medical reference library application begins, as shown in FIG. 3 (“AMIRSYS™” and “POCKETRADIOLOGIST®” are both trademarks of Amirsys, Inc. of Salt Lake City, Utah).

As seen in FIG. 3, when the electronic medical reference library application is launched, an “installed title” screen 60 appears, wherein a listing of installed titles 62 is displayed. In this embodiment, the installed titles 62 are a series of clinical radiology reference books written by leading doctors/authors in the field. However, as would be apparent to one skilled in the art, the installed titles 62 could be references pertaining to virtually any specialty, or body area. Whatever the specific content, each title 62 follows an identical format.

By arranging the information in this manner, the same information is in the same place every time enabling quick reference. Navigation can therefore be much quicker

In the embodiment depicted in FIG. 3, the first title 62 is the top 100 Musculoskeletal diagnoses. The second and third titles 62 are the top 100 diagnoses in Head & Neck and Brain respectively.

In this embodiment, each title 62 occupies about 1 MB of memory, enabling most PDAs to hold multiple titles 62. All titles 62 may include color imagery and the same version of each title 62 runs on monochrome (black and white) PDA screens as well as color PDA screens.

The installed titles screen 60 functions as a library or “book shelf” for all titles (or “books”) 62 that are installed (i.e., available for reading) on the PDA device. In this embodiment, the installed titles screen 60 is the first screen of the electronic medical reference library application. The list may include as many titles 62 as will fit into the memory of the PDA device.

The user may select the desired title 62 by tapping it, and then open the title 62 by tapping the open button 61. Any installed title 62 can thus be opened for reading. In FIG. 3 the title “Head and Neck 100” is selected.

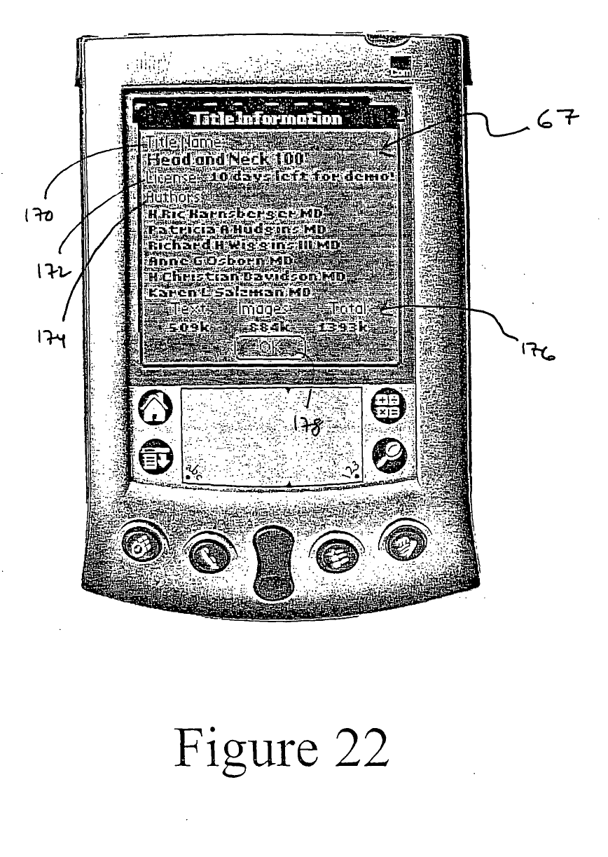

Included on the installed titles screen 60 is an information button 66 which, when activated, opens a “title information” window 67 (FIG. 22) on a selected title 62. If no title is selected when the information button 66 is activated, the default selection is the first title on the installed title list 64.

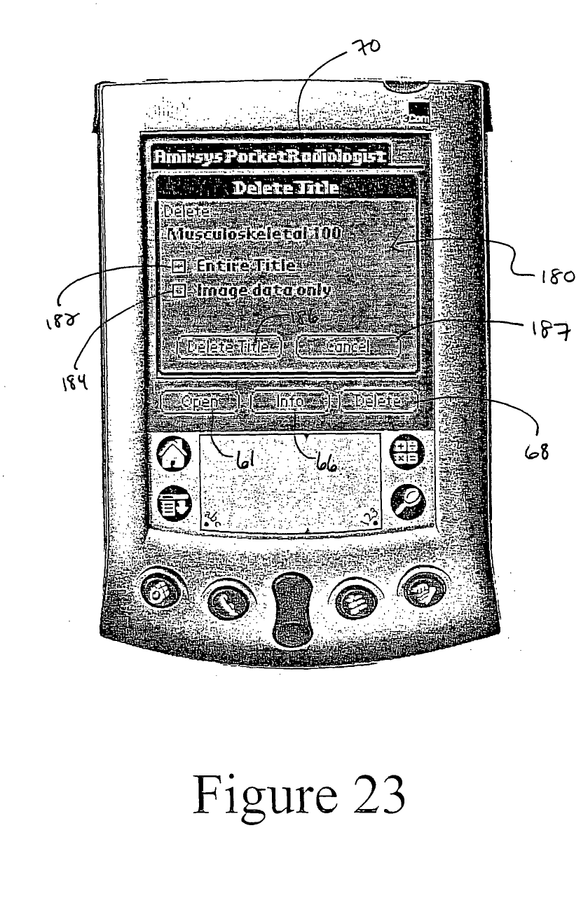

The delete button 68 when activated opens the “delete title” window 69 (FIG. 23) for that particular title 62. Again, if no title 62 is selected when the information button 66 is activated, the default selection is the first title on the installed title list.

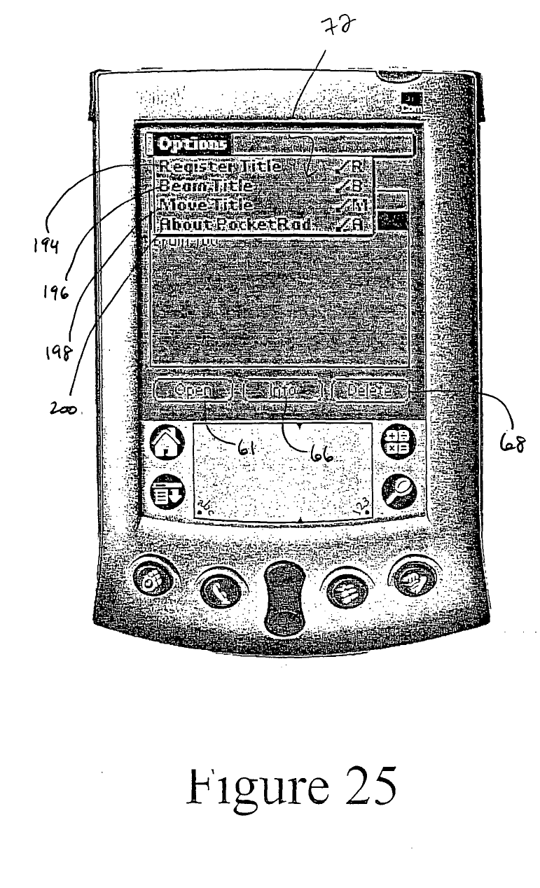

In the installed titles screen 60, there is also a title options pull down 70. The title options pull down 70, when activated, displays a title options pull down menu or options list 72 (shown in FIG. 25), which, in this embodiment, provides four options: 1) “Register Title;” 2) “Beam Title;” 3) “Move Title;” and 4) “About PocketRadiologist.” As will be discussed further below, when a title 62 is selected, and the pull down menu 72 is activated, the user is given a number of options with respect to the title 62.

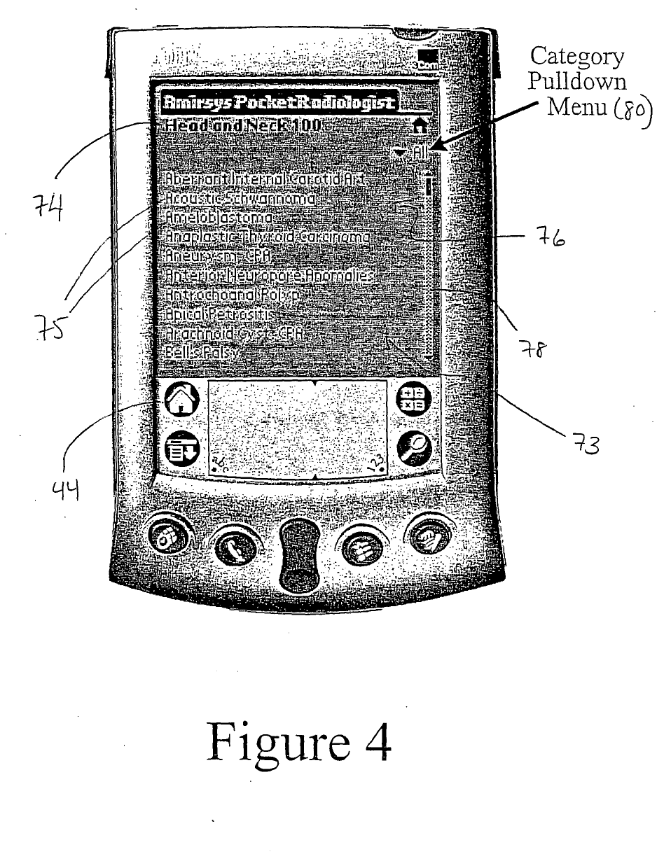

As seen in FIG. 4, when a user taps twice on, or otherwise opens, a title 62, a title screen 73 is displayed having the title name 74, and below it, a table of contents, or in the present case, a diagnosis list 76 for that particular title 62. In the present embodiment, the title “Head and Neck” was selected, and the table of contents 76 displayed is a list of 100 head and neck diagnoses 75 (which correspond to different “chapters” in the title). The diagnoses in this embodiment are listed in alphabetical order.

When the table of contents 76 is displayed, the title options pull down 70 is no longer actionable. A scroll bar 78 is located on the right side of the screen, permitting a user to view the entire table of contents 76 by scrolling through the chapters 75 (or in the present case, diagnosis list).

When a user locates the particular diagnosis 75 he/she is looking for, he/she simply can tap twice on the diagnosis 75 to select and open it.

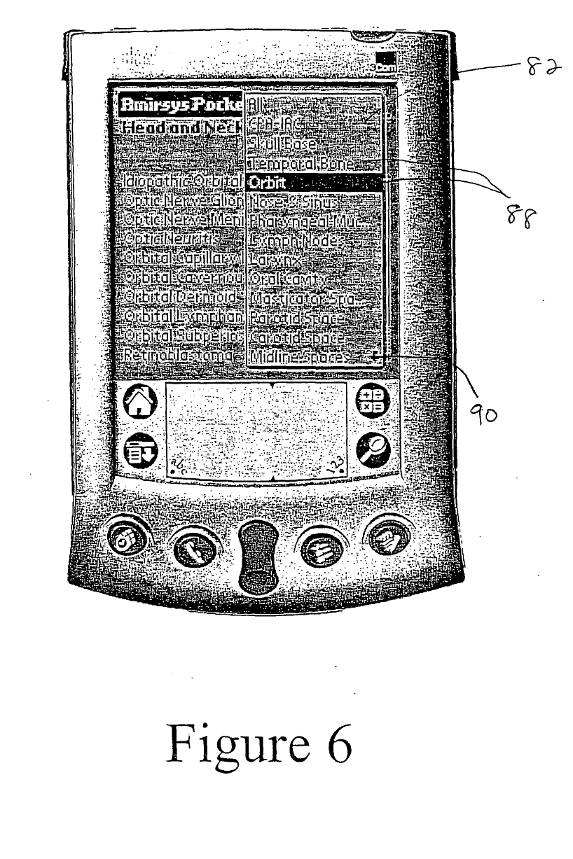

A category pull down menu button 80 can also be tapped to open a category pull down menu 82 (FIG. 6).

In this embodiment, to get back to the installed titles screen 60, a user would tap the application launcher icon 44.

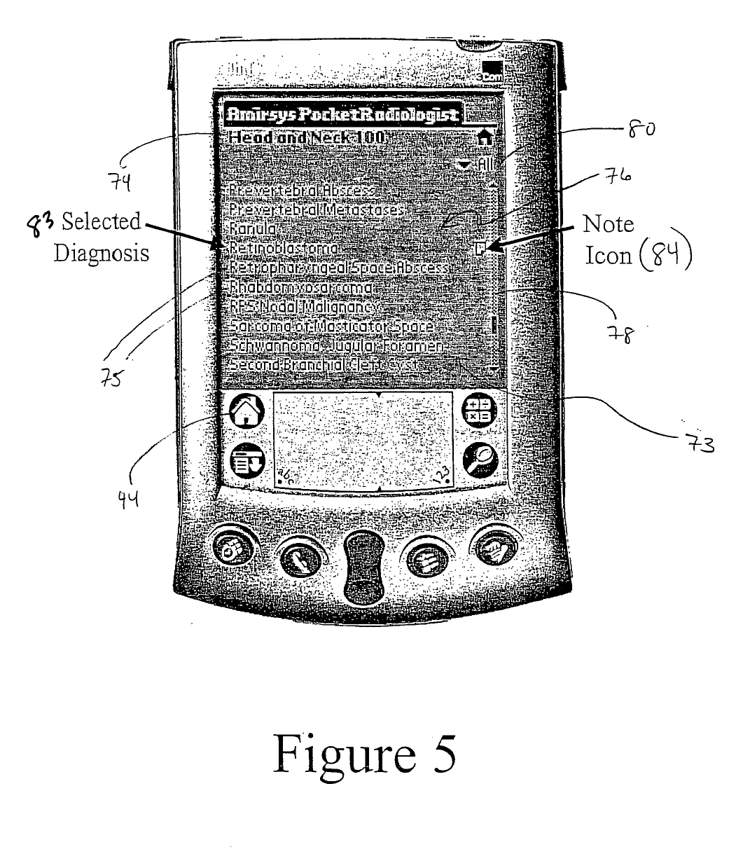

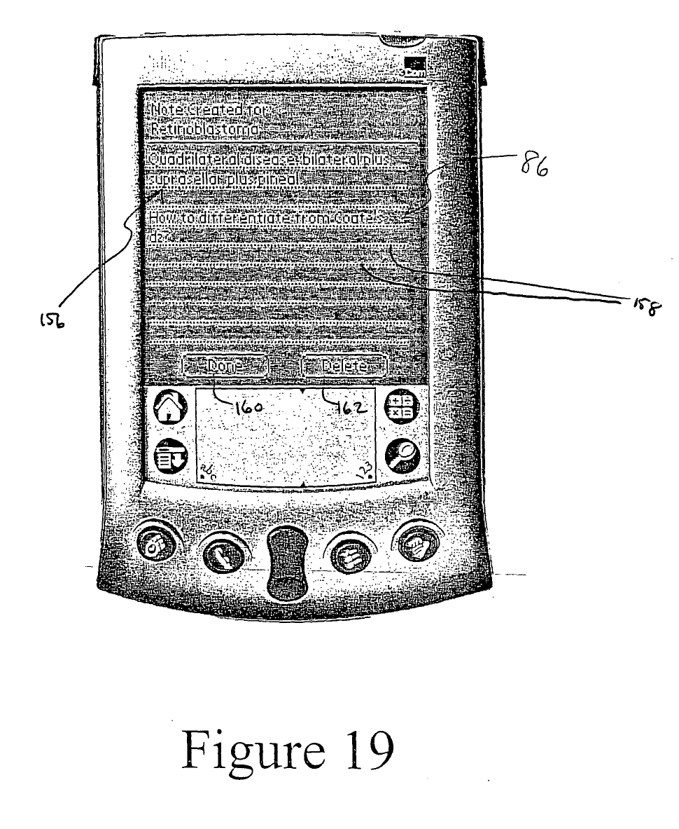

FIG. 5 illustrates the diagnosis list as shown in FIG. 4, but scrolled further down. As can be seen in this figure, next to the diagnosis “Retinoblastoma” 83 a note icon 84 is visible. The note icon 84 denotes that the user has previously entered notes pertaining to this diagnosis (or chapter) 75. By tapping on the note icon 84, a user can open the note screen 86 (FIG. 19). Upon exiting the note screen 86, the user will be returned to diagnosis list or title screen 73.

As mentioned above, the category pull down menu button 80 allows a user to refine his/her research according to subcategories of chapters or diagnoses 75 which are displayed in the diagnosis list 76. As seen in FIG. 6, the category pull down menu button 80, when tapped, opens up a category pull down menu 82, listing various subcategories 88 by which a user can refine the diagnosis list 76 categories by choosing logical sub-categories, such as anatomical region or pathology.

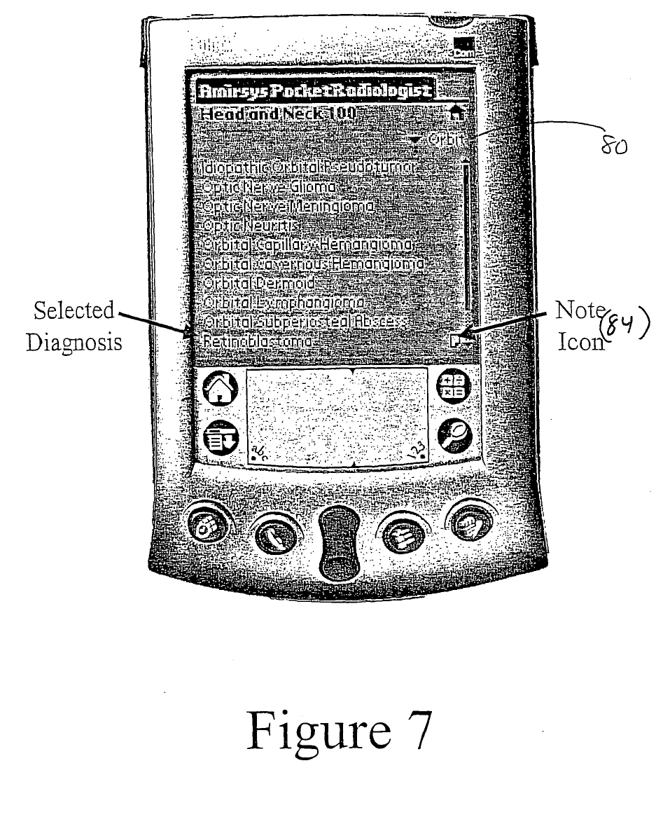

To illustrate, in FIG. 5, the category pull down menu button 80 indicates that “All” the chapters or diagnoses 75 are being displayed in the diagnosis list. However, when a user activates the category pull down menu 82 and selects a particular subcategory 88, such as the “Orbit” subcategory as shown in FIG. 6, then the diagnosis list 76 is further refined to diagnoses pertaining specifically to that subcategory, as shown in FIG. 7.

The category pull down menu 82 can be scrolled through by using the scrolling button 90. Note that in FIG. 7 the category pull down menu button 80 is now labeled “Orbit”, indicating the current category selection.

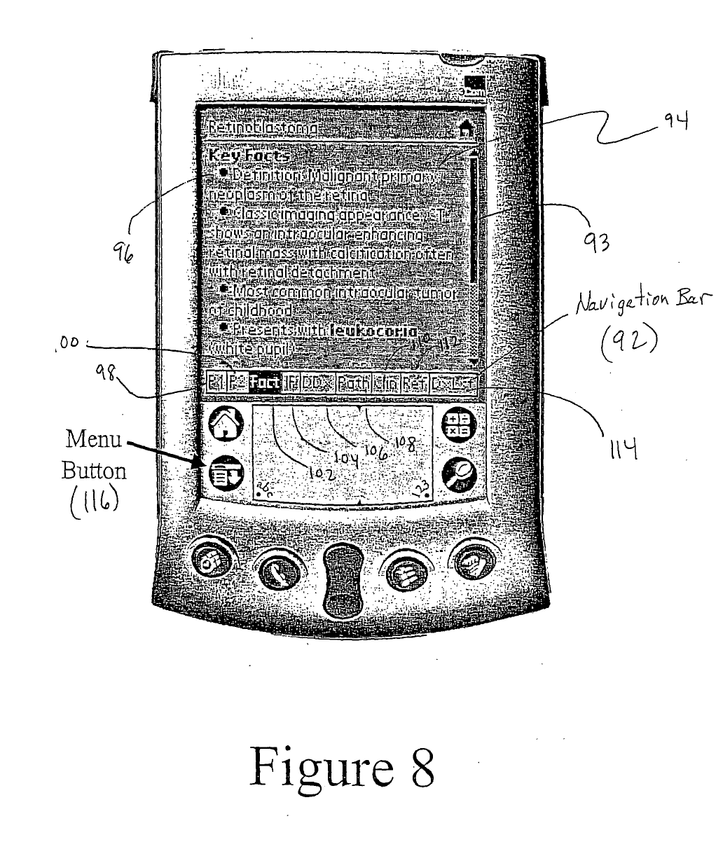

Once a diagnosis 75 is selected, it opens up to a key fact screen 94. As seen in FIG. 8, the key fact screen 94 provides a brief bulleted summary of the diagnosis 96. These bulleted facts can be scrolled through using the scroll bar 93 to the right of the screen. The user can navigate through the diagnosis in a non-linear fashion using the navigation bar 92. The navigation bar 92 navigates to all screens of the diagnosis and is displayed on all text screens of the diagnosis. The navigation bar 92 also includes a button 114, which when activated, takes a user back to the diagnosis list 76.

Fast screen selection is enabled by tapping on the navigation bar 92 buttons. In FIG. 8, the “Fact” button 102 is highlighted to indicate that the key facts screen 94 is currently selected. In this embodiment, each diagnosis includes two image screens 103, 140, a key facts screen 94, an imaging findings screen 117, a differential diagnosis screen 118, a pathology screen 120, a clinical issues screen 122, and a select references screen 123. The navigation bar 92 in the present embodiment includes buttons directing a user to each of the foregoing pages. Specifically, the picture buttons “P1” 98 and “P2” 100 will direct a user the first 103 and second 140 image screens respectively; the key facts button 102 will direct a user to the key facts screen 94; the imaging findings button 104 will direct a user to the imaging findings screen 117; the differential diagnosis button 106 will direct a user to the differential diagnosis screen 118; the pathology button 108 will direct a user to the pathology screen 120; the clinical issues 110 button will direct a user to the clinical issues screen 122; and the select references 112 button will direct a user to the select references screen 123.

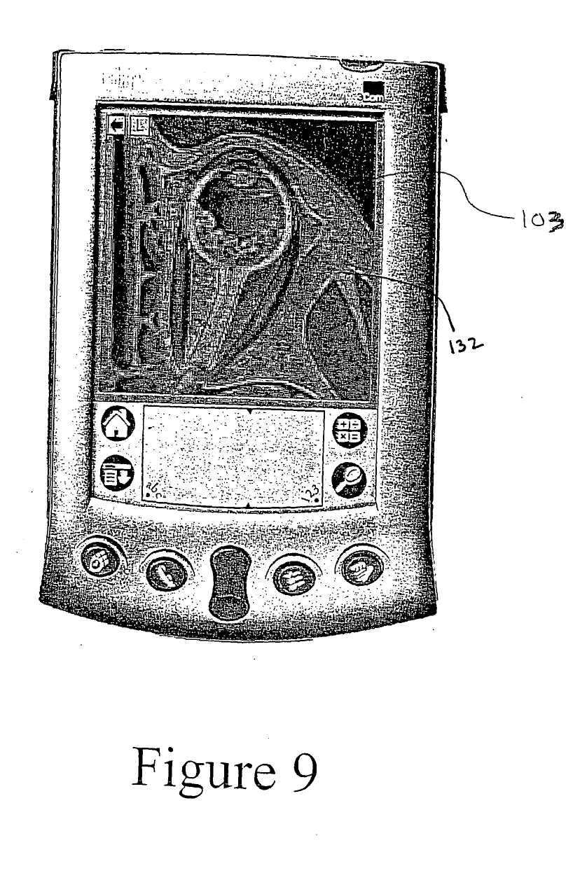

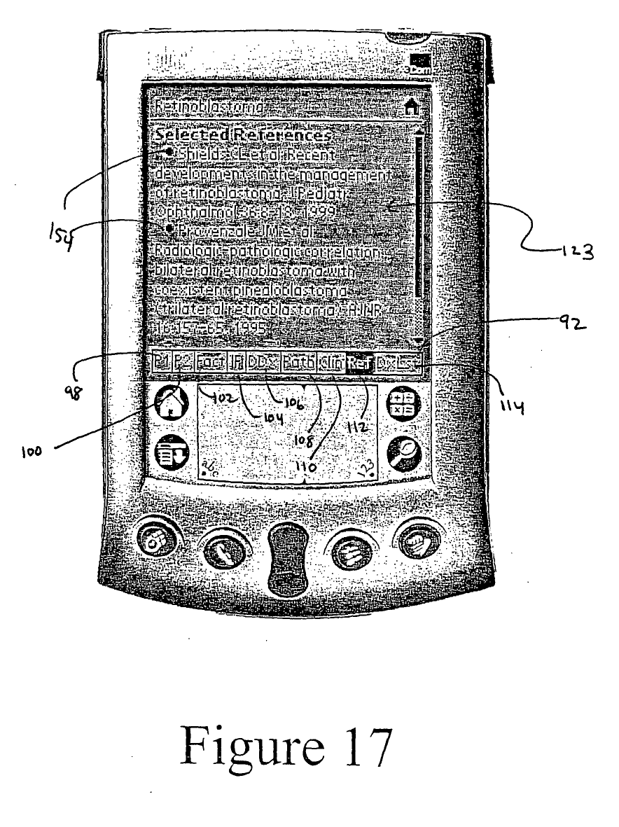

As is apparent in FIGS. 9-17, each time a particular screen is displayed, the corresponding button is highlighted (e.g. when the select references screen 123 is displayed, the select references button 112 is highlighted as seen in FIG. 17. It is also noted that by having every title in a uniform format such as this, navigation is much quicker and easier.

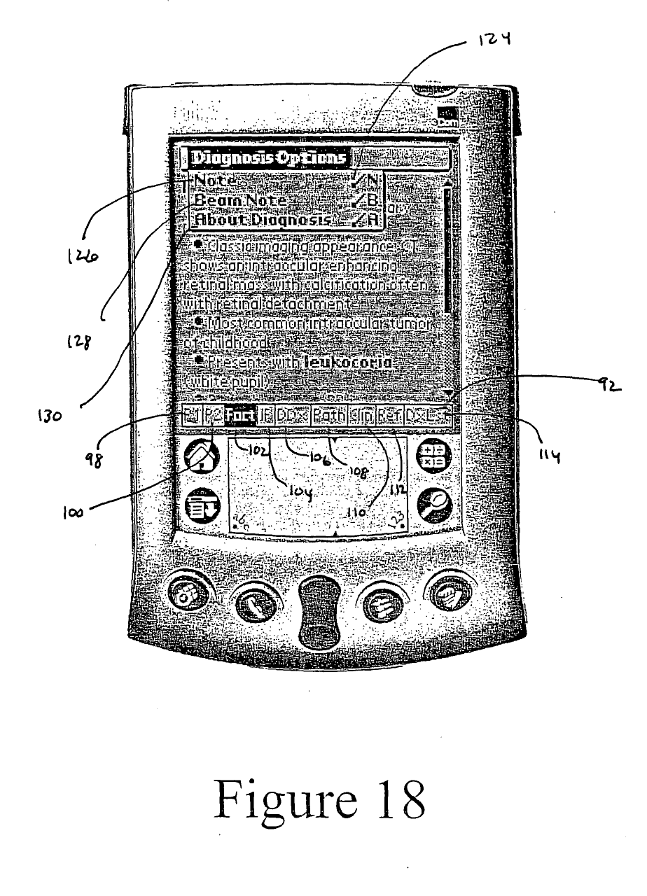

Referring again to FIG. 8, a menu button 116, which in the present embodiment is the built-in PDA button, when tapped, displays a diagnosis options pull down menu 124 (FIG. 18) at the top of the screen. Some of the options available in the pull down menu 124 can include a note option 126, which allows users to add their own notes to the diagnosis; a beam note option 128 which allows users to beam their notes to other PDAs with beaming capability; and an about diagnosis option 130, which includes information pertaining to the particular diagnosis such as the title name, diagnosis name, and author name.

In one embodiment, “text only” versions of the titles are installed. This is particularly appealing for users with limited PDA memory. In this case, imagery will not be installed and navigation to images will not function.

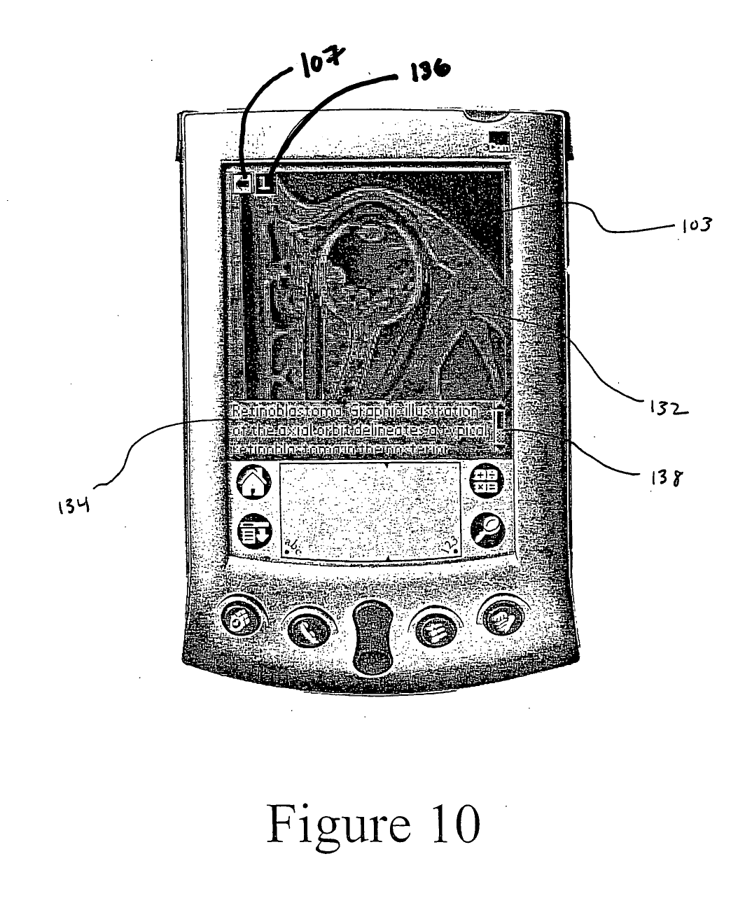

Referring more particularly to FIGS. 9-17, in FIG. 9 is seen an example of a first picture screen 103. This screen 103 may contain either radiological imagery or a full color illustration developed to designate classic features of the diagnosis and to help visualize the disease state. This particular example shows an illustration 132. As shown in FIG. 10, the illustration 132 can also contain a legend (i.e., caption) 134 that can be toggled to display or be hidden by tapping the “L” button 136. The legend or caption 134 in this embodiment is a pop-up text box that is turned on as an overlay across the bottom of the illustration 132.

As would apparent to one skilled in the art, images such as these are extremely valuable in helping the healthcare provider visualize the disease state.

In this embodiment, there is also a previous text page return button 107 that returns the user to the previous text page. It is also noted that, in this embodiment, the “L” button 136 is highlighted (indicated by a darkened background) to denote that it has been activated. To hide the legend 134, a user would simply tap the “L” button 136 a second time. As with other screens, a scroll bar 138 can be employed to view the complete text.

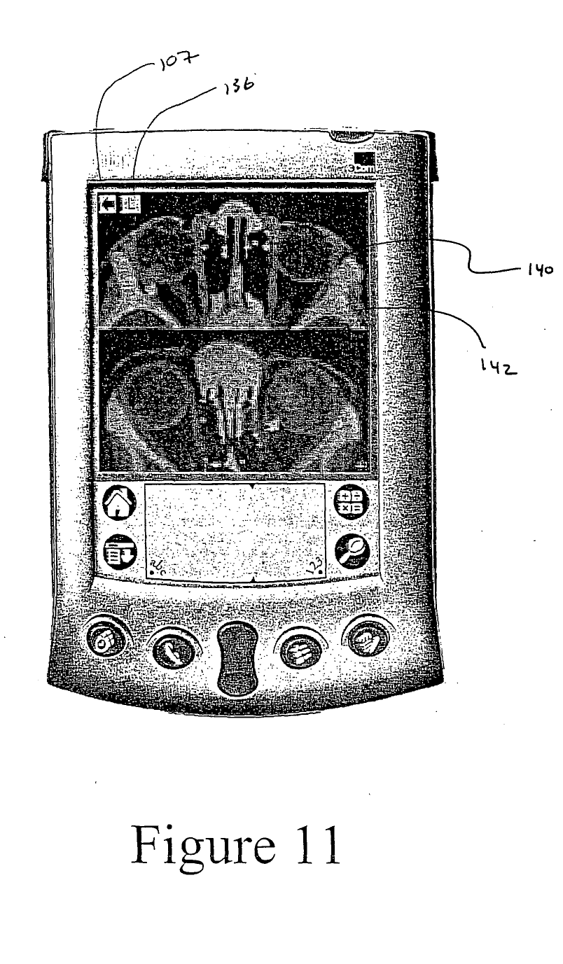

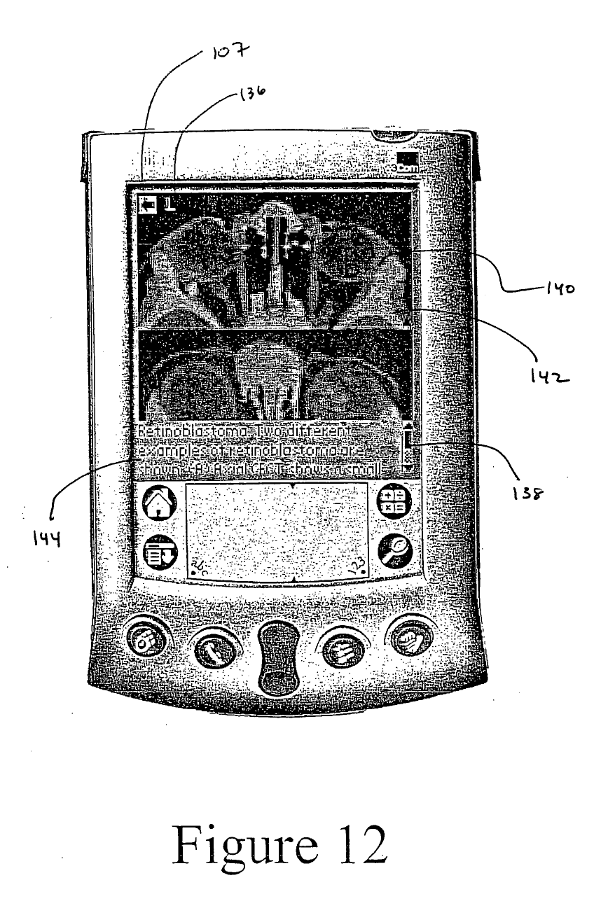

FIGS. 11 and 12 depict the second picture screen 140. As with the first picture screen 103, this screen 140 may contain either radiological imagery or a full color illustration developed to designate classic features of the diagnosis and to help visualize the disease state. This particular example shows a radiological image 142.

As with the first picture screen 103 (FIG. 9), this picture screen 140 also contains a legend (i.e., caption) 144 that can be toggled to display or be hidden by tapping the “L” button 136. Similar to the first picture legend 134, this screen shows the legend (i.e., caption) as a pop-up text box that can be toggled to display or be hidden by tapping the “L” button 136. Again, the “L” button 136 is highlighted in this example (indicated by a darkened background) to indicate it has been activated.

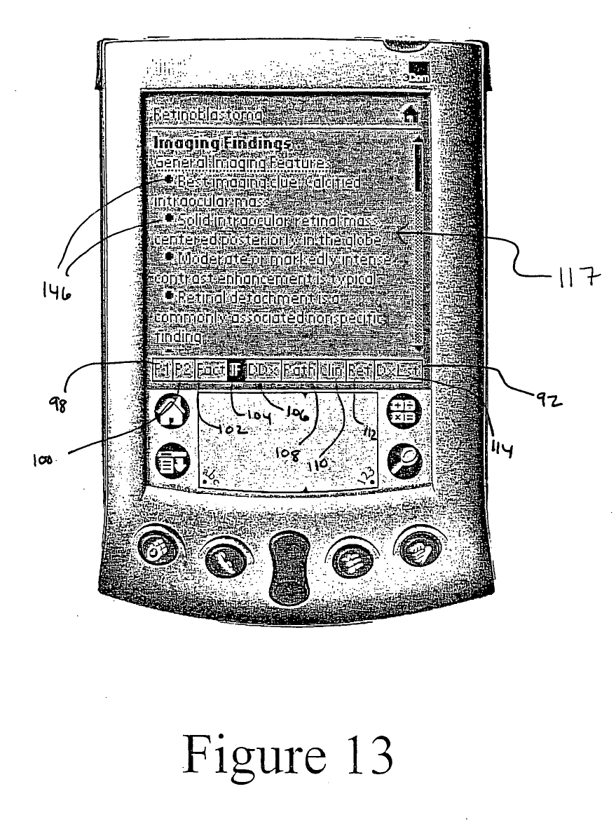

FIG. 13 depicts the image findings screen 117 discussed briefly above. This screen 117 lists important general imaging characteristics 146 of the diagnosis and often includes details specific to imaging modalities appropriate to the diagnosis, e.g., CT, MR. Imaging recommendations are also provided.

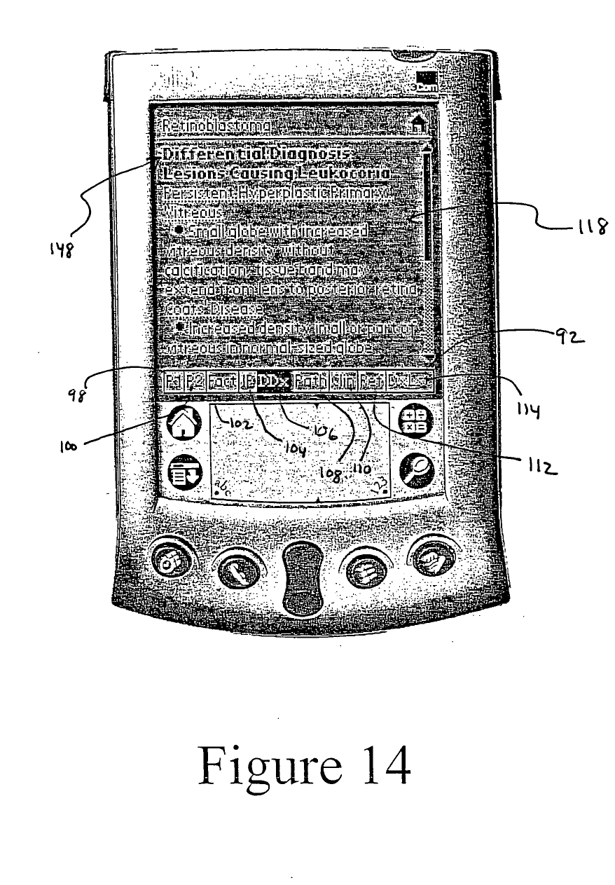

FIG. 14 depicts the differential diagnosis screen. This screen provides alternative diagnoses 148 that may be similar to the diagnosis being described in image findings or presentation. This information is especially valuable when trying to rule out potential diagnoses.

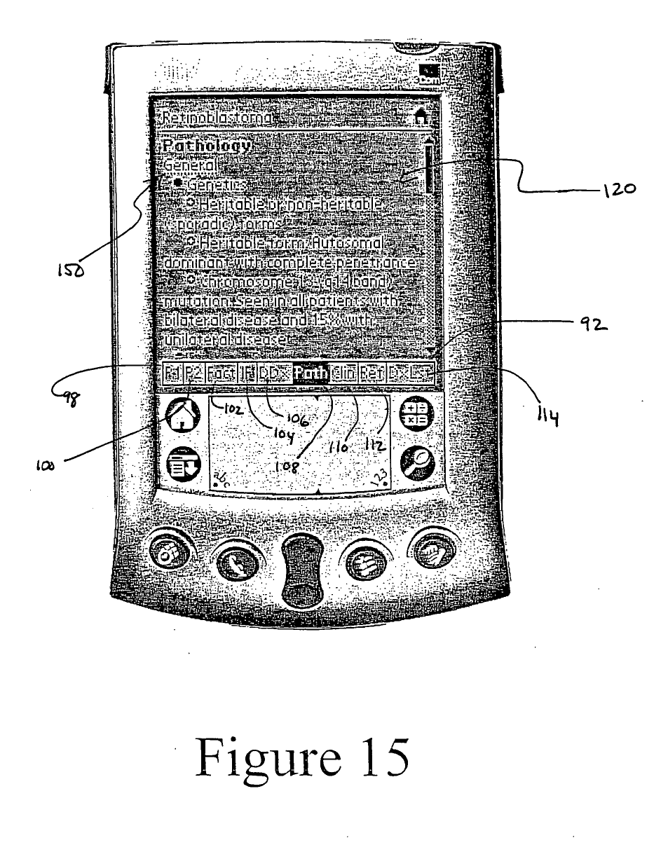

FIG. 15 depicts the pathology screen 120. This screen highlights general pathology observations 150 about the diagnosis, i.e., the structural and functional deviations from the normal that constitute disease or characterize a particular disease. Pathology has many dimensions including genetics, etiology (i.e., causes), epidemiology (i.e., incidence, distribution, and control of disease in a population), associated abnormalities, gross pathologic and surgical features visible to the unaided eye, microscopic features, and staging/grading criteria.

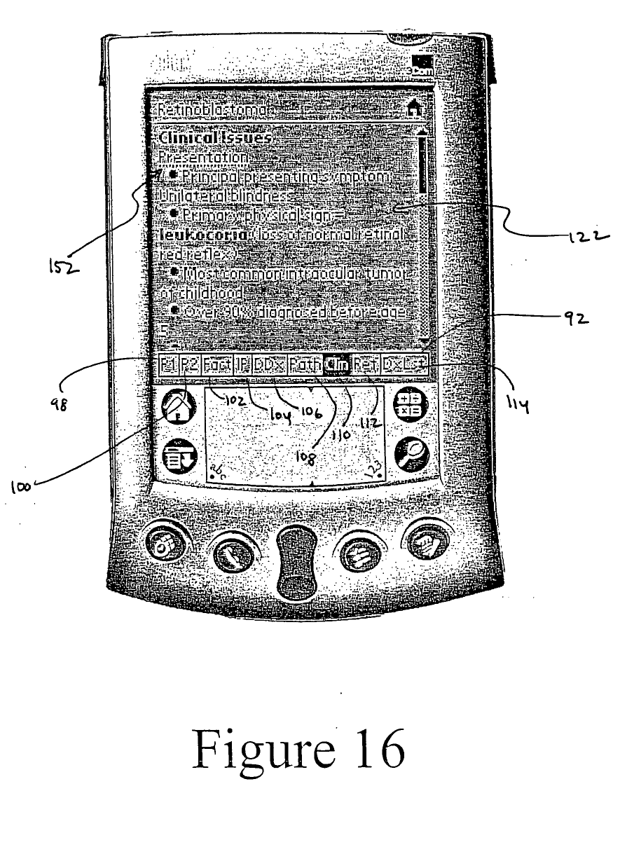

FIG. 16 depicts the clinical issues screen 122. This screen summarizes clinical presentation of the diagnosis (i.e., symptoms) 152 and often includes highlights of the natural history (i.e., the general course or progression), treatment, and prognosis (i.e., probable outcomes) of the disease.

FIG. 17 depicts a selected reference screen 124. This screen lists selected references 154 specific to every diagnosis for further research and reference.

FIG. 18 illustrates an embodiment of a diagnosis options pull down menu 124. As discussed previously, the pull down menu 124 includes a list of three diagnosis options: the “Note” option 126, the “Beam Note” option 128 and the “About Diagnosis” option 130.

By tapping on the “beam note” option 128, a user can beam his/her note about a particular diagnosis to another party (provided that other party has beaming capability).

By tapping on the “note option” 126, a user is taken to a note screen 86. FIG. 19 depicts an example of a note screen 86. This screen 86 allows users to enter their own notes associated with a diagnosis 75 via standard PDA text entry methods. For example, users can create a personal summary of information 156 from the diagnosis or enter pertinent information from other sources. The invention anticipates using the note screen 86 as a mechanism for users to submit suggestions, comments, corrections, and additional information to the publisher for consideration to be included in future additions of the title.

The note screen 86 in this embodiment features ruled lines 158 resembling a page of a notebook. The user enters notes via standard PDA text entry methods. The “Done” button 160 returns the user to the previous screen after the desired note is entered. As mentioned above, once a note has been entered for a diagnosis 75, a note icon 84 appears to the right of that diagnosis name on the diagnosis list screen as shown in FIGS. 5 and 7. Tapping on the note icon 84 opens the note screen 86 for the particular diagnosis/chapter 75. When the note screen is opened from the note icon, exiting the note screen returns to the Diagnosis List Screen.

The delete button 162 when activated deletes the contents of the note screen.

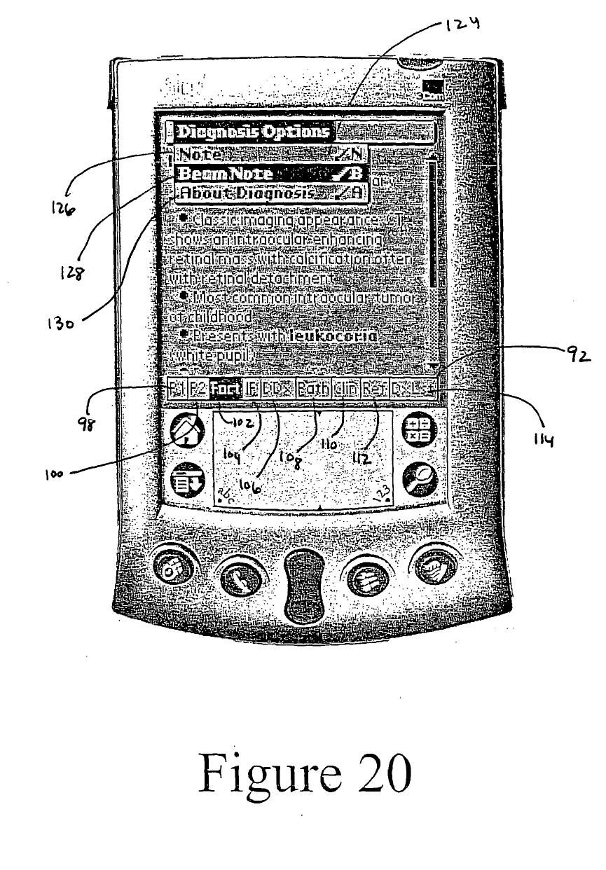

FIG. 20 further illustrates the beam note 128 option in the diagnosis options pull down menu 124. This option 128 allows a user to beam his/her own note associated with a diagnosis 75 in a particular title 74 to another PDA with beaming capabilities and with the same reference installed. In the present embodiment, if the receiving PDA already has a note associated with the same diagnosis as the sending PDA, the sending PDA's note will be appended to the receiving PDA's note.

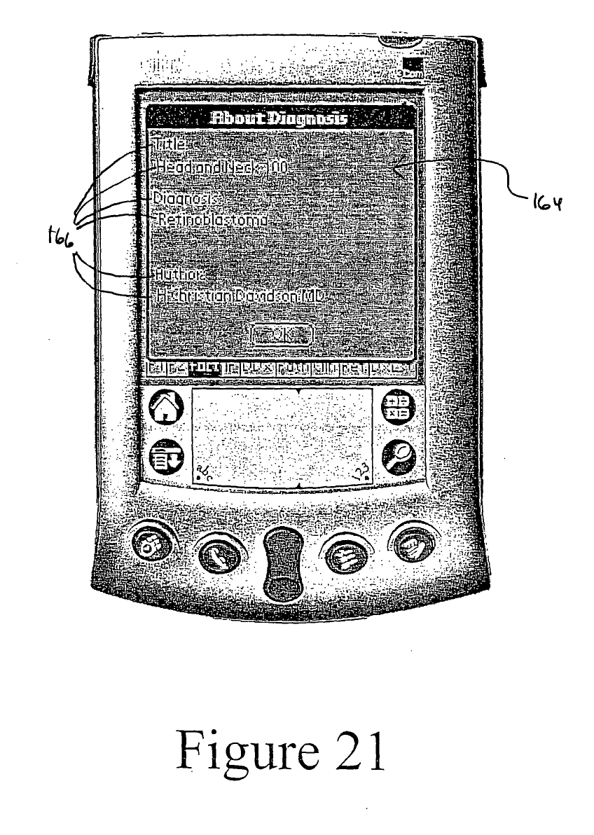

If a user taps on the “about diagnosis” option 130, an “about diagnosis” window 164 will appear as shown in FIG. 21. This window 164 displays information 166 about the current diagnosis. It can include information such as title name, diagnosis name, and name of the author of the diagnosis. To return to previous screen, a user would simply tap the “OK” button 168.

As discussed in connection with FIG. 3, when a user desired information about a particular title 62, he/she can select the title 62 by tapping on it once. The user can then tap on the title information button 66. A title information window 67 will then appear, as shown in FIG. 22. This window 67 displays information about the selected title such as title name 170, license information 172, authors' names 174, and memory usage 176.

Again, when a user desires to return to the previous screen he or she simply taps the “OK” button 178.

If a user desires to delete a title 62 from the installed title list (FIG. 3), he/she would similarly tap the delete button 68. A “delete title” window 180 would then appear as shown in FIG. 23. This window 180 displays options for deleting a selected title. In the present embodiment, the window 180 includes a checkbox 182 labeled “Entire Title” as well as a checkbox 184 labeled “Image Data Only.” If either of these boxes is checked, the other checkbox cannot be selected—i.e., the checkboxes are mutually exclusive. If neither box is checked, nothing is deleted.

By selecting the “Image Data Only” box 184, only image data is deleted. Similarly, by selecting the “Delete Title” box 182, the entire title is deleted from the system. If deletion is not desired, then the operation can be cancelled by simply hitting the cancel button 187 and the user will return to the previous screen.

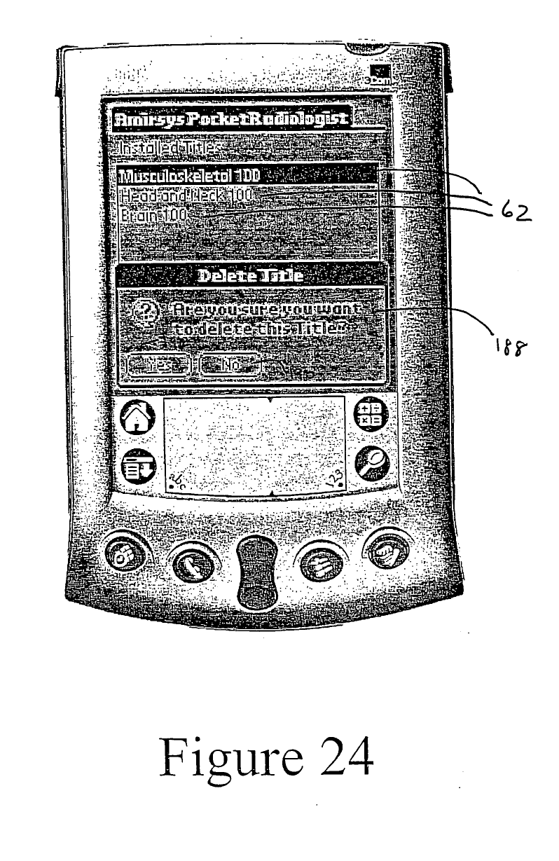

As a safety net, upon requesting deletion of images or a complete title (e.g. by tapping on the “delete title” button 186), a Delete Title Confirmation Window 188 will appear ensuring that deletion is the desired result, as seen in FIG. 24. If deletion is, in fact the desired action, then a user would tap the “Yes” button 192 and the deletion would be carried out. If deletion is not desired, then a user would tap the “No” button 190 and the action would be cancelled.

FIG. 25 depicts the Title Options Pull Down Menu 72, which can be accessed by tapping on the title options pull down 70. The Pull Down Menu 72 allows a user to select from the following options: the “Register Title” option 194, the “Beam Title” option 196, the “Move Title” option 198 and the “About” option 200. These options allow the user to gather more information regarding the reference, or to effectuate a loan of the reference.

When a user taps on the “Register Title” option 194, he or she can then enter a license key and register a particular title 62. In this embodiment, titles may be purchased via CD-ROM or can be downloaded on-line.

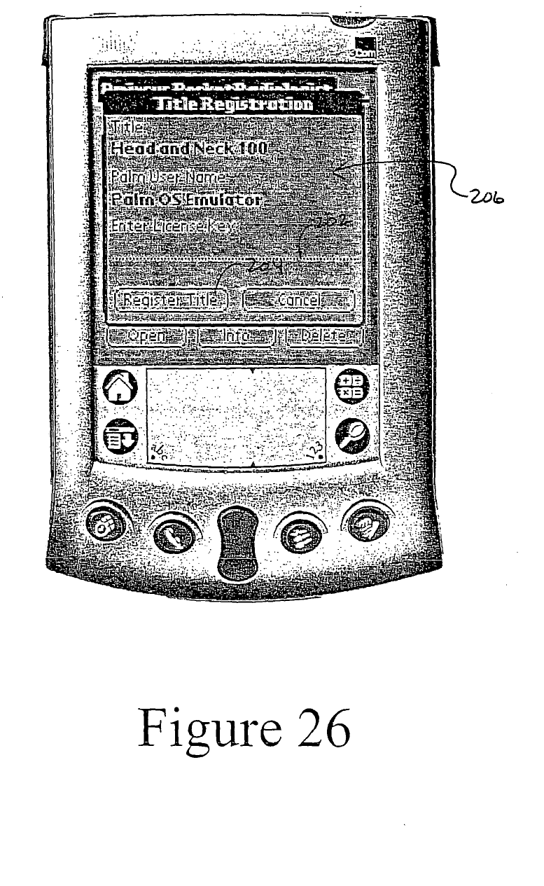

In one embodiment, a ten-day trial period can be given before requiring a license key to be entered. If the trial period has expired, the new user will get a message instructing him or her that the license key needs to be purchased before the book can be opened again. Each originally purchased CD-ROM would come with a license key. On-line download customers could purchase a license key via the product web site, which would then be delivered electronically. In this embodiment, the license key would have to be entered to open the “locked” book. An example of a Register Title window is depicted in FIG. 26, where the license key would be entered, via standard PDA text entry, onto line 202. The user would then tap the “Register Title” button 204.

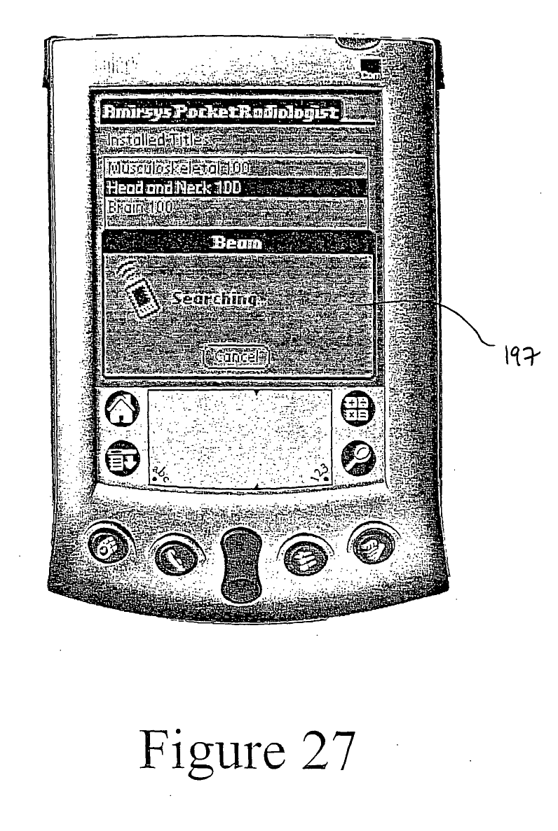

The Beam Title option 196 permits a user to beam a complete title 62 to other PDAs. This allows a user to “loan” the book to another user that does not have the particular book. This loan is authorized for a fixed period of time, (e.g. 10 days), before the book is locked shut. By purchasing a pass key from the appropriate authority, the book can be enabled for future viewing. FIG. 27 depicts an example of a Beam Title window 197.

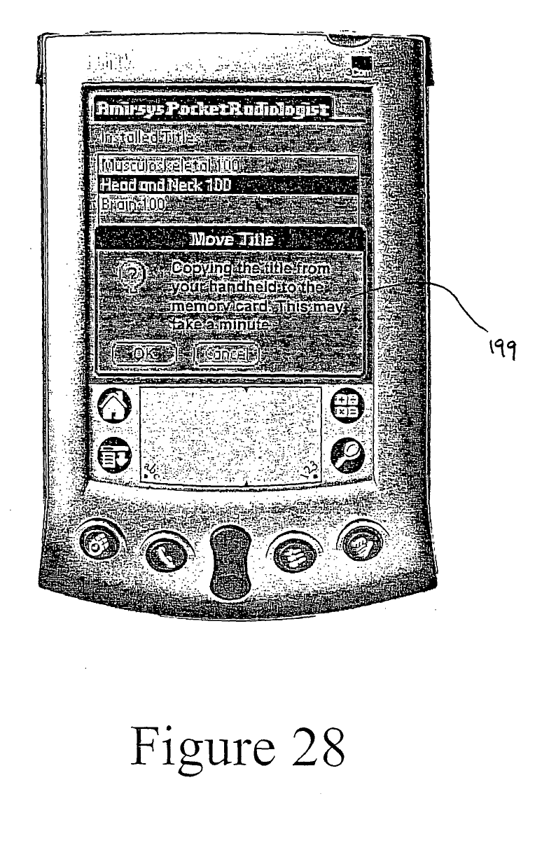

Move Title option 198 permits a user to move a title 62 between the PDA's main memory and a memory expansion card or similar device. A typical Move Title window 199 is depicted in FIG. 28.

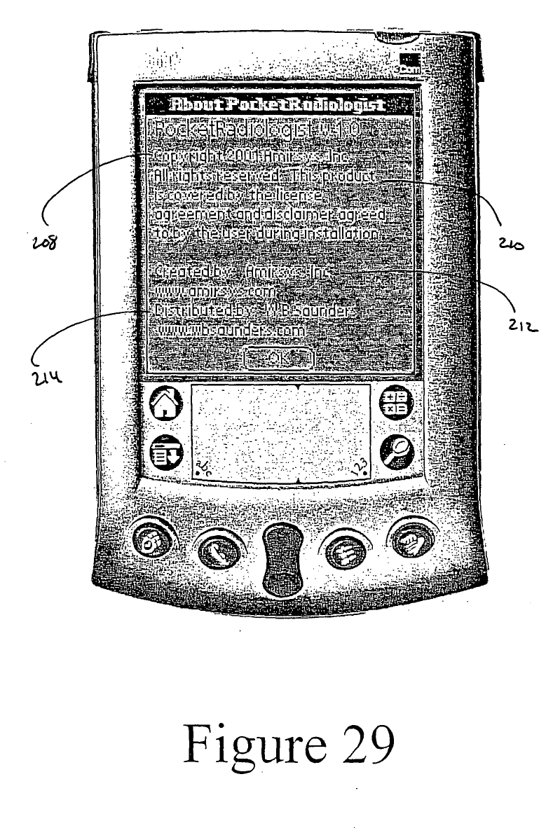

The final option listed in the Options Pull Down Menu is an “About” option 200. As depicted in FIG. 29, when the “About” option is selected, it can provide the user with product information such as copyright information 208, end user license agreements 210, disclaimers, and identifies the product creator 212 and distributor 214.

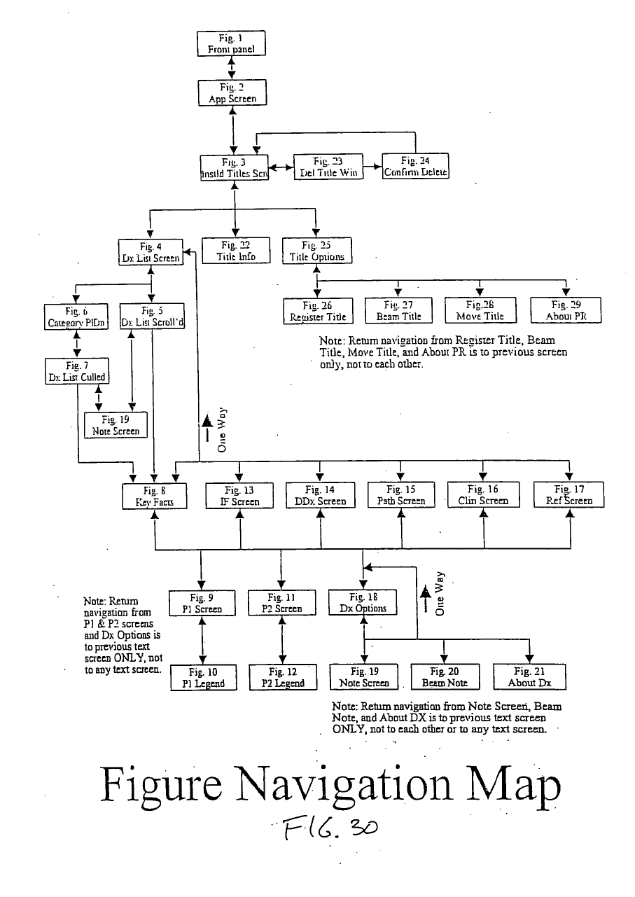

FIG. 30 schematically depicts the interaction of the various aspects of the embodiment depicted in FIGS. 1-29.

### DEFINITION OF TERMS

Electronic Book—is a book represented in electronic media, not hard bound in paper, typically stored in a computer or PDA.

Electronic Medical Reference Title—is a title that is listed in electronic form, i.e. a title that represents the actual reference, which can be selected from a list of other electronic references listed, such as a book on a library shelf.

Body of Knowledge—is any information gathered on a particular subject matter, which can be found in a variety of forms: books, newspapers, periodicals, theses, consortium notes, symposia dictations, and/or any other scholarly or independent works.

Internet—is any worldwide system of computer networks by which users at any one linked computer can get information from, or other access to, any other linked computer.

### VARIATIONS OF THE ILLUSTRATED INVENTION

It is understood that the above-described arrangements are only illustrative of the application of the basic principles of the present invention. Numerous modifications and alternative arrangements may be devised by those skilled in the art without departing from the spirit and scope of the present invention. The appended claims are intended to cover such modifications and arrangements.

For example, it is noted that there is no requirement for the basic principal of the illustrated invention to be strictly related to medical technology. It is contemplated by the present invention to include other fields, such as engineering, law, chemistry, physics, literature, accounting, business, and history. The prior lists are not exhaustive but merely illustrative of the wide birth of applications for the basic concepts of the present invention. The only criteria that is universally applied to the above listed items is a need to provide detailed and comprehensive material related to a specific area of knowledge that is, at least partially, based on image recognition and assessing certain issues for an appropriate course of action.

Therefore, to outline the general form of the presently illustrated invention (not limited to the field of medical diagnosis) there is described: an electronic body of knowledge (designated by title) which is displayed for electronic selection, a list of individual categories of knowledge that are related to the selected body of knowledge, a navigation bar which is displayed after electronic selection of an individual category of knowledge, a list of key facts that are related to a selected category of knowledge which are displayed after an individual category of knowledge is electronically selected or after having its representative button selected on the navigation bar, and an image which illustrates a representative view of an individually selected category of knowledge, which has a representative button on the navigation bar, and which is displayed after having its representative button selected on the navigation bar.

Although it is illustrated that the buttons and images have certain shapes, sizes, and positions, for example, each is contemplated to be variable with respect to all of those characteristics.

It may be illustrated in each of the embodiments to use a particular type of PDA (personal digital assistant), however, it is well within the capabilities of one skilled in the art to easily adapt the basics of the claimed features of the present invention into any other form of digital media display means. For example, cell phones with display screens are clearly contemplated, as well as wireless networks and other digital displays. The only limit is the necessity for providing a means for some display mechanism and navigation means between successive screen displays. Therefore, this invention is not limited to a small profile device, like a PDA, but is intended to offer an electronic navigation means for a complex assembly of information that is related to, and has function with, imagery or figures.

1. A device for storing and managing an electronic medical reference library, comprising:
a) an electronic medical reference, designated by title, displayed for electronic selection;
b) a list of individual diagnoses, to be displayed for electronic selection after electronic selection of the electronic reference;
c) a navigation bar, displayed after electronic selection of an individual diagnosis, having representative buttons located thereon for electronic selection;
d) a list of key facts, related to a selected individual diagnosis, having a representative button on the navigation bar, displayed after an individual diagnosis is electronically selected or after having its representative button selected on the navigation bar; and
e) an image, illustrating a representative view of an individually selected diagnosis, having a representative button on the navigation bar, displayed after having its representative button selected on the navigation bar.

2. The device for storing and managing an electronic medical reference library of claim 1, wherein the list of diagnoses is displayed in alphabetical listing.

3. The device for storing and managing an electronic medical reference library of claim 1, wherein the list of diagnoses is displayed in alphabetical listing based upon a particular category of diagnosis.

4. The device for storing and managing an electronic medical reference library of claim 1, further comprising a picture legend, displayed after electronic selection of a legend button displayed on the displayed picture.

5. The device for storing and managing an electronic medical reference library of claim 1, further comprising a list of images related to a selected individual diagnosis, having a representative button on the navigation bar, displayed after having its representative button selected on the navigation bar.

6. The device for storing and managing an electronic medical reference library of claim 1, further comprising a list of differential diagnoses, related to a selected individual diagnosis, having a representative button on the navigation bar, displayed after having its representative button selected on the navigation bar.

7. The device for storing and managing an electronic medical reference library of claim 1, further comprising a list of pathology information, related to a selected individual diagnosis, having a representative button on the navigation bar, displayed after having its representative button selected on the navigation bar.

8. The device for storing and managing an electronic medical reference library of claim 1, further comprising a list of clinical issues information, related to a selected individual diagnosis, having a representative button on the navigation bar, displayed after having its representative button selected on the navigation bar.

9. The device for storing and managing an electronic medical reference library of claim 1, further comprising a list of selected references information, related to a selected individual diagnosis, having a representative button on the navigation bar, displayed after having its representative button selected on the navigation bar.

10. The device for storing and managing an electronic medical reference library of claim 1, further comprising a note page that allows a user to add personal notes that are permanently related to a selected individual diagnosis.

11. The device for storing and managing an electronic medical reference library of claim 1, further comprising a notes beaming function, that allows a user to send personal notes to another user of a portable electronic medical reference library that has the same electronic medical reference book title.

12. The device for storing and managing an electronic medical reference library of claim 1, further comprising an electronic medical reference beaming function, that allows an original user to send a selected electronic medical reference to a second user that has a personal digital assistant so the second user can use the selected electronic medical reference for a specified period of time before being disabled.

13. The device for storing and managing an electronic medical reference library of claim 12, further comprising a function that allows the second user to receive authorization for the continued use of the beamed selected electronic medical reference sent from the original user.

14. A device for storing and managing an electronic library of knowledge, comprising:
a) an electronic body of knowledge, designated by title, displayed for electronic selection;
b) a list of individual categories of knowledge, related to the reference selected, to be displayed for electronic selection after electronic selection of the electronic reference;
c) a navigation bar, displayed after electronic selection of an individual category of knowledge, having representative buttons located thereon for electronic selection;
d) a list of key facts, related to a selected individual category of knowledge, having a representative button on the navigation bar, displayed after an individual category of knowledge is electronically selected or after having its representative button selected on the navigation bar; and
e) an image, illustrating a representative view of an individually selected category of knowledge, having a representative button on the navigation bar, displayed after having its representative button selected on the navigation bar.

15. The device for storing and managing an electronic library of knowledge of claim 14, further comprising an electronic beaming function, that allows an original user to send a selected electronic body of knowledge, as designated by title, to a second user that has a personal digital assistant so the second user can use the selected body of knowledge for a specified period of time before being disabled.

16. The device for storing and managing an electronic library of knowledge of claim 15, further comprising a function that allows the second user to receive authorization for the continued use of the beamed information sent from the original user.

17. The device for storing and managing an electronic library of knowledge of claim 14, further comprising a note page that allows a user to add personal notes that are permanently related to a selected category of knowledge.

18. The device for storing and managing an electronic library of knowledge of claim 14, further comprising a notes beaming function, that allows a user to send personal notes to another user of a portable electronic library of knowledge that contains the same electronic body of knowledge.

19. The device for storing and managing an electronic library of knowledge of claim 14, wherein the electronic library of knowledge is related to a professional area of practice requiring recognition of a visual item to assist a professional in making a decision.

20. The device for storing and managing an electronic library of knowledge of claim 19, wherein the professional area of practice is medicine.

21. The device for storing and managing an electronic library of knowledge of claim 19, wherein the professional area of practice is engineering.

22. The device for storing and managing an electronic library of knowledge of claim 19, wherein the professional area of practice is automobile maintenance and repair.

23. The device for storing and managing an electronic library of knowledge of claim 14, wherein the professional area of practice is accounting.

24. The device for storing and managing an electronic library of knowledge of claim 14, wherein the professional area of practice is chemistry.

25. The device for storing and managing an electronic library of knowledge of claim 14, wherein the professional area of practice is visual art.

26. The device for storing and managing an electronic library of knowledge of claim 14, wherein the professional area of practice is law.

27. The device for storing and managing an electronic library of knowledge of claim 14, wherein the professional area of practice is business.

28. The device for storing and managing an electronic library of knowledge of claim 14, wherein the professional area of practice is language.

29. The device for storing and managing an electronic medical reference library of claim 1, wherein the device for storing and managing an electronic medical reference is a personal digital assistant.

30. The device for storing and managing an electronic library of knowledge of claim 14, wherein the device for storing and managing an electronic medical reference is a personal digital assistant.
